(19) United States
(12) Patent Application Publication
(10) Pub. No.: US 2004/0021986 A1
(43) Pub. Date: Feb. 5, 2004

(54) Disk cartridge and disk drive thereof

(75) Inventor: Harumi Aoishi, Odawara-shi (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/630,839

(22) Filed: Jul. 31, 2003

(30) Foreign Application Priority Data
Jan. 8, 2002 (JP) 224799/2002

(51) Int. Cl. G11B 23/03

(52) U.S. Cl. 360/133

(57) ABSTRACT

In a disk cartridge provided with a rotary shutter, incorporating suitability is improved as an initial speed of ejection and a balance of the cartridge are ensured by a coil spring which urges the rotary shutter to a closed position. A coil spring 14 is formed to have an effective length shorter than a rotation stroke of the rotary shutter 7. Acompanying ejection of the disk cartridge from a disk drive, a shutter knob 7b of the rotary shutter 7 engages with the shutter closing means, which is made of an elastic member provided in the disk drive. Thus, the rotary shutter 7 is led to the closed position.

### BACKGROUND OF THE INVENTION

1. Field of the Invention

The present invention relates to a disk cartridge in which a discoid recording medium is rotatably contained in a housing and which is inserted into a slot provided in a disk drive to be placed in the disk drive, and to a disk drive thereof.

2. Description of the Related Art

Recording media, e.g., a micro-magnetic disk cartridge called “clik! (registered trademark)” have been conventionally used for mobile equipment such as digital cameras.

FIGS. 6(a) to (c) are a plan view, a right side view, and a bottom plan view showing a closed rotary shutter 7 of a magnetic disk cartridge 1, respectively. FIGS. 7(a) and (b) are a plan view and a bottom plan view showing the opened rotary shutter 7, respectively. As shown in these Figures, a flat housing of the magnetic disk cartridge 1 rotatably contains a magnetic disk 5. The flat housing is constituted of a resin frame 2 which includes a pressing portion 2a, and upper and lower shells 3 and 4 which are made of thin metal plates. The dimensions of the housing are 50 mm wide by 55 mm deep by 1.95 mm thick. The magnetic disk 5 has a storage capacity of 40 MB and a diameter of 1.8 inches (45.7 mm).

The magnetic disk cartridge 1 is constituted so as to be inserted and placed in a disk drive 20 as shown in FIG. 9. A V-shaped opening 6 and the rotary shutter 7 are provided in the housing. The opening 6 is for a magnetic head 27 of the disk drive 20 to access the surface of the magnetic disk 5, and the rotary shutter 7 opens and closes the opening 6.

In addition, a notch 8 is formed in the top portion on the left side of the housing. The notch 8 ensures the positioning in the disk drive 20 by engaging with an engaging member 29 located in the disk drive 20. A small window 9 is formed in the top portion on the right side so that a shutter locking member 11 which locks the rotary shutter 7 at a closed position faces outside.

A circular opening 4a and an arcuate groove 4b are formed in the lower shell 4 of the housing. The opening 4a is for fitting a spindle 23 of the disk drive 20 to a center core 10 of the magnetic disk 5. The arcuate groove 4b is concentric with the rotary shutter 7. A shutter knob 7b is attached to the rotary shutter 7. The shutter knob 7b protrudes from the arcuate groove 4b and moves along the arcuate groove 4b to open and close the rotary shutter 7.

FIGS. 8(a) and (b) are plan views showing the closed and opened rotary shutter 7 by removing the upper shell 3 and omitting the magnetic disk 5, respectively.

A convex engaging portion 11a which can be inserted into a concave engaging portion 7c formed on the periphery of the rotary shutter 7 is provided on the tip of a shutter locking member 11. The shutter locking member 11 which locks the rotary shutter 7 at a closed position is rotatably attached to a shaft 12 provided in the housing. The shutter locking member 11 is urged by a spring plate 11b to a direction where the convex engaging portion 11a can be inserted into the concave engaging portion 7c (counterclockwise direction in FIG. 8). The shutter locking member 11 is constituted as follows: when the magnetic disk cartridge 1 is inserted into the disk drive 20, a lock releasing member 19 provided in the disk drive 20 passes through the small window 9 to press the shutter locking member 11; accordingly, the locking member 11 is slightly rotated clockwise, and the convex engaging portion 11a escapes from the concave engaging portion 7c; thus the lock on the rotary shutter 7 is released.

The rotary shutter 7 is urged by a thin long coil spring 14 with a small diameter to a closing direction (counterclockwise direction in FIG. 8). To attach this coil spring 14, a guide wire 13 is provided. One end of the guide wire 13 is fixed to a frame 2 at a portion 2b which faces the periphery of the rotary shutter 7. The other end slidably penetrates a supporting member 7d fastened to the periphery of the rotary shutter 7 and extends along the periphery of the rotary shutter 7. As shown in FIG. 8(a), the coil spring 14 is compressed and attached between the portion 2b of the frame 2 and the supporting member 7d to expand and compress along the guide wire 13. The coil spring 14 urges the rotary shutter 7 to the closing direction (counterclockwise direction in FIG. 8). When the rotary shutter 7 released from the lock is rotated clockwise in FIG. 8 from this state, the coil spring 14 is compressed as shown in FIG. 8(b).

The disk drive 20 shown in FIG. 9 is a Type II PC card drive which has the dimensions of 53 mm wide by 86 mm deep by 5 mm thick. The disk drive 20 includes a slot 21, a spindle motor 22, a head actuator 24, a swing arm 25 and a head suspension 26. The disk cartridge 1 is inserted into the slot 21. The spindle motor 22 is provided with a spindle 23 which magnetically attracts the center core 10 of the magnetic disk 5. The head suspension 26 is supported by the swing arm 25. On the tip of the head suspension 26, a magnetic head 27 is disposed to access the surface of the rotating magnetic disk 5 to record and reproduce information.

The disk drive 20 further includes a push-push cartridge engaging/releasing mechanism 28 and an input/output interface 30. The cartridge engaging/releasing mechanism 28 includes the engaging member 29 which engages with a notch 8 of the magnetic disk cartridge 1. The input/output interface 30 is for electronic equipment such as digital cameras and personal computers to which this disk drive 20 is installed.

Inside the slot 21 of the disk drive 20, an engaging wall 18 which bilaterally extends to be orthogonal to an insertion direction of the magnetic disk cartridge 1 is formed on the right side as shutter opening means. A lock releasing member 19 is also provided to release the rotary shutter 7 locked at the closed position when inserting the magnetic disk cartridge 1.

When the magnetic disk cartridge 1 is inserted into the slot 21 of the disk drive 20, first, the lock releasing member 19 presses the shutter locking member 11, and the shutter knob 7b engages with the engaging wall 18 under that condition. Accordingly, acompanying the insertion of the magnetic disk cartridge 1, the rotary shutter 7 is rotated so as to compress the coil spring 14 while the shutter knob 7b slides along the engaging wall 18. Accordingly, the rotary shutter 7 is opened as shown in FIGS. 7(a) and (b) and FIG. 8(b). Simultaneously, the engaging member 29 of the disk drive 20 engages with the notch 8 of the magnetic disk cartridge 1. As shown in FIG. 8(b), the magnetic disk cartridge 1 is loaded to a predetermined position in the disk drive 20 while the coil spring 14 is still compressed.

By contrast, when ejecting the magnetic disk cartridge 1, the cartridge engaging/releasing mechanism 28 pushes out the magnetic disk cartridge 1 by pressing the pressing portion 2a of the magnetic disk cartridge 1. At the same time, an initial speed of ejection is ensured by the compressed coil spring 14. Moreover, acompanying the ejection of the magnetic disk cartridge 1, the coil spring 14 urges the rotary shutter 7 so that the rotary shutter 7 is rotated to the closed position shown in FIGS. 6(a) and (c) and FIG. 8(a) and locked by the shutter locking member 11.

Incidentally, in the foregoing conventional magnetic disk cartridge 1, a long coil spring 14 has been employed as means for urging the rotary shutter 7 toward the closed position in order to securely operate the rotary shutter 7, as apparent from FIG. 8(a). The long coil spring 14 extends over the entire length of the rotation stroke of the rotary shutter 7. Nevertheless, there has been a disadvantage that it is difficult to incorporate such long coil spring 14 into the housing of the magnetic disk cartridge 1, and thus the incorporating suitability has been unsatisfactory.

To overcome the foregoing problem, the coil spring 14 can be removed. However, the coil spring 14 is necessary to ensure the initial speed for ejecting the magnetic disk cartridge 1 from the disk drive 20 and keep the balance between the initial speed and the operation of the cartridge engaging/releasing mechanism 28 upon ejection.

### SUMMARY OF THE INVENTION

In consideration of the foregoing circumstances, a first object of the present invention is to provide a magnetic disk cartridge in which the incorporating suitability of a spring member is improved while an initial speed of ejection and a balance of the cartridge are secured by the spring member.

A second object of the present invention is to provide a disk drive which is suitable for placing a magnetic disk cartridge of the present invention thereinto.

The first invention of this application is a disk cartridge in which a discoid recording medium is rotatably contained in a housing and which is inserted into a slot formed in a disk drive to be placed in the disk drive.

The housing includes an opening, a rotary shutter and locking means. The opening is for a read/write head of the disk drive to access the surface of the recording medium. The rotary shutter opens/closes the opening while being urged by a spring member to a closing direction. The locking means locks the rotary shutter at a closed position.

The disk cartridge is constituted as follows: acompanying insertion of the disk cartridge into the disk drive, a lock on the rotary shutter is released by lock releasing means and shutter opening means which are provided in the disk drive; and subsequently, the rotary shutter is rotated to an open position so as to compress the spring member.

The disk cartridge is characterized by that the spring member has an effective length shorter than a rotation stroke of the rotary shutter and that the rotary shutter is led to a closed position, accompanied by ejection of the disk cartridge from the disk drive.

The effective length of the spring member is preferably about ¼ to ¾ of the rotation stroke of the rotary shutter.

The spring member can be constituted by a coil spring which stretches and shrinks along a guide wire extended along the periphery of the rotary shutter.

Furthermore, an arcuate groove which is concentric with the rotary shutter is formed in the housing of the disk cartridge, and a shutter knob which protrudes from the arcuate groove and can be moved along the arcuate groove is attached to the rotary shutter. This shutter knob engages with an engaging wall, which is a shutter opening means provided in the disk drive, upon insertion of the disk cartridge, and the rotary shutter is rotated to an open position.

The second invention of this application is a disk drive which includes a slot, a driving mechanism and a read/write head. A disk cartridge in which a discoid recording medium is rotatably contained in a housing is inserted into the slot. The driving mechanism rotates the recording medium to be driven. The read/write head accesses the surface of the rotating recording medium to record and reproduce information.

The housing of the disk cartridge is provided with an opening, a rotary shutter and locking means. The opening is for the read/write head to access the surface of the recording medium. The rotary shutter opens and closes the opening while being urged by a spring member to a closed position. The locking means locks the rotary shutter at the closed position.

The disk drive further includes lock releasing means and shutter opening means. The lock releasing means releases the rotary shutter locked by the locking means upon insertion of the disk cartridge into the disk drive. Subsequently, the shutter opening means rotates the rotary shutter to an open position against the urging force of the spring member.

The disk drive is characterized by that the disk drive further includes shutter closing means made of an elastic member. The shutter closing means engages with the rotary shutter when ejecting the disk cartridge from the disk drive. Thereafter, the shutter closing means leads the rotary shutter to the closed position.

An arcuate groove which is concentric with the rotary shutter is formed in the housing of the disk cartridge. To this rotary shutter, a shutter knob is attached. The shutter knob protrudes from the arcuate groove and can move along the arcuate groove in accordance with the rotation of the rotary shutter. The aforementioned shutter opening means can be constituted by an engaging wall which engages with the shutter knob upon insertion of the disk cartridge.

In addition, the shutter closing means made of the elastic member can be constituted as follows: the shutter closing means engages with the shutter knob upon insertion of the disk cartridge into the disk drive; moreover, the shutter closing means is bent by the shutter knob to allow the shutter knob to pass through; when ejecting the disk cartridge from the disk drive, the shutter closing means engages with the shutter knob and leads the rotary shutter to the closed position; and thereafter, the shutter closing means is bent by the shutter knob to allow the shutter knob to pass through.

The elastic member can be made of metal or resin having the shape of a plate spring.

According to the disk cartridge of the present invention, the spring member which urges the rotary shutter to a closing direction has the effective length shorter than the rotation stroke of the rotary shutter. Therefore, since the spring member is easily incorporated into the cartridge housing, the incorporating suitability can be improved.

Furthermore, although the spring has the effective length shorter than the rotation stroke of the rotary shutter, the spring is compressed when the rotary shutter is at the open position. Therefore, similar to the conventional disk cartridge, the initial speed of ejection and the balance of the cartridge can be ensured.

Incidentally, in the case where the spring member has an effective length of, for example, half the rotation stroke of the rotary shutter, the urging force of the spring member stops acting in the middle of the operation when ejecting the disk cartridge from the disk drive. Accordingly, the rotary shutter stops, approximately half closed. However, by providing the disk drive with, for example, the shutter closing means made of the elastic member, the rotary shutter (shutter knob) engages with the elastic member upon ejection. Thus, the slightly bent elastic member rotates the rotary shutter, on which the urging force of the spring member is not acting, to the closed position. Moreover, the rotary shutter is locked by the shutter locking means at the closed position.

Thereafter, at the final step of ejection, the elastic member is bent by the shutter knob of the rotary shutter which is locked at the closed position. Thus, the shutter knob is allowed to pass through, and the disk cartridge can be ejected.

Meanwhile, when inserting the disk cartridge into the disk drive, the shutter knob is engaged with the shutter closing means before the lock releasing means releases the lock on the rotary shutter at the closed position, owing to a positional relationship between the lock releasing means and the shutter closing means. In this case, the shutter closing means made of the elastic member is bent to allow the shutter knob to pass through. Thus, at this point, the shutter knob is engaged with the shutter opening means while the lock on the rotary shutter is released by the lock releasing means, and the rotary shutter is rotated to the open position.

Moreover, when inserting the disk cartridge into the disk drive, the rotary shutter locked at the closed position is released by the lock releasing means. Thereafter, when the shutter knob is engaged with the elastic member, the shutter closing means, the urging force of the spring member does not act on the rotary shutter at all. Thus, the slightly bent elastic member rotates the rotary shutter halfway. Subsequently, the urging force of the spring member starts to act on the rotary shutter. Accordingly, the elastic member is bent to allow the shutter knob to pass through, and the shutter knob engages with the shutter opening means to rotate the rotary shutter to the open position.

Therefore, according to the disk drive of the present invention, it is apparent that the disk drive does not only function for the disk cartridge of the present invention, but also suits the conventional disk cartridge shown in FIGS. 6 to 8. This is because the only structural modification is the simple addition of the shutter closing means made of the elastic member to the conventional disk drive shown in FIG. 9.

### BRIEF DESCRIPTION OF THE DRAWINGS

FIGS. 1(a) and (b) are plan views showing a magnetic disk cartridge of the present invention when a rotary shutter is closed and opened by removing an upper shell and omitting a magnetic disk, respectively.

FIG. 2 is a plan view showing the magnetic disk cartridge of FIG. 1 when the rotary shutter stops in the middle of closing.

FIG. 3 is a plan view showing a disk drive of the present invention.

FIGS. 4(a) to (c) are explanatory views showing sequential operations of an elastic member when inserting the magnetic disk cartridge shown in FIG. 1 into the disk drive shown in FIG. 3.

FIGS. 5(a) to (e) are explanatory views showing sequential operations of the elastic member when ejecting the magnetic disk cartridge shown in FIG. 1 from the disk drive shown in FIG. 3.

FIGS. 6(a) to (c) are a plan view, a right side view and a bottom plan view showing a conventional magnetic disk cartridge when the rotary shutter is closed, respectively.

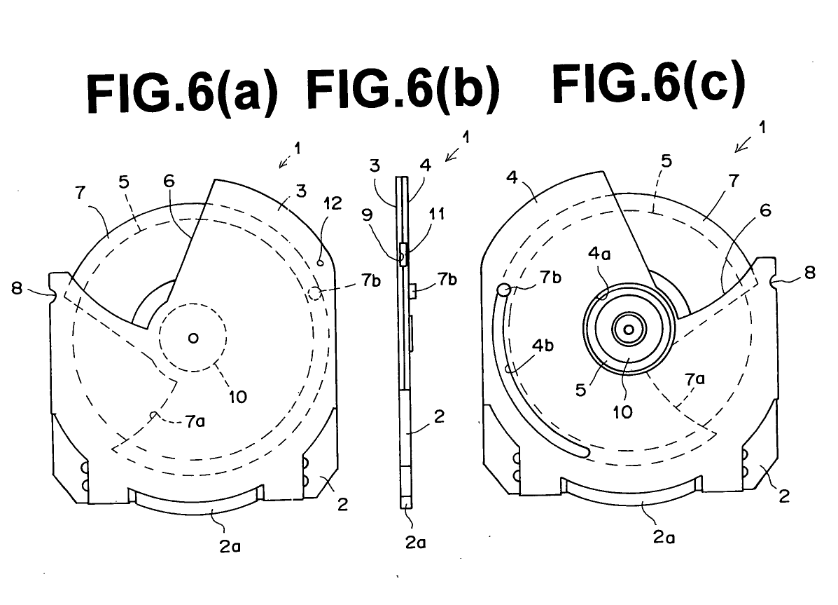

FIGS. 7(a) and (b) are a plan view and a bottom plan view showing the conventional magnetic disk cartridge when the rotary shutter is opened, respectively.

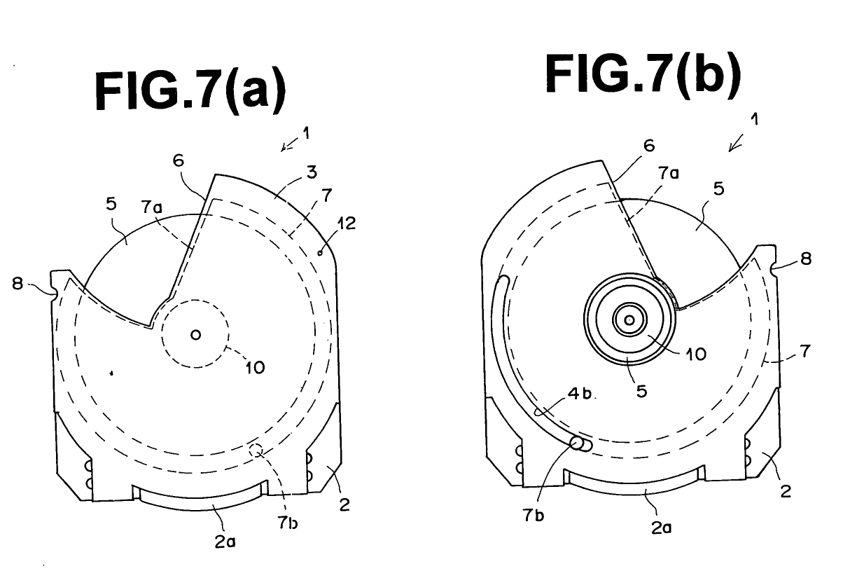

FIGS. 8(a) and (b) are plan views showing the conventional magnetic disk cartridge when the rotary shutter is closed and opened by removing the upper shell and omitting the magnetic disk, respectively.

FIG. 9 is a plan view showing a conventional disk drive.

### DESCRIPTION OF THE PREFERRED EMBODIMENT

An embodiment of the present invention is detailed below with reference to the attached drawings.

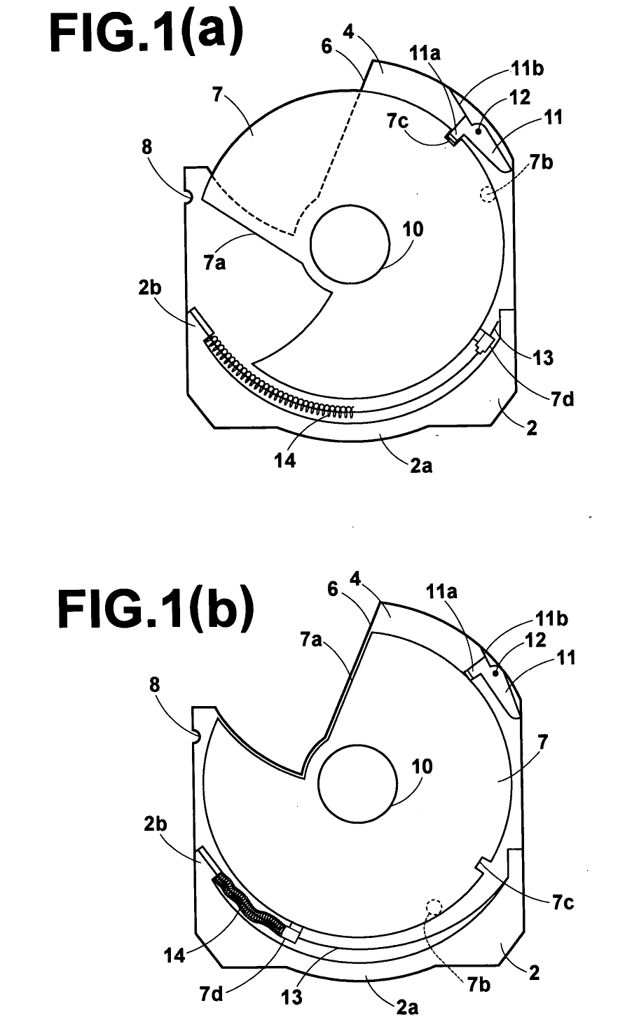

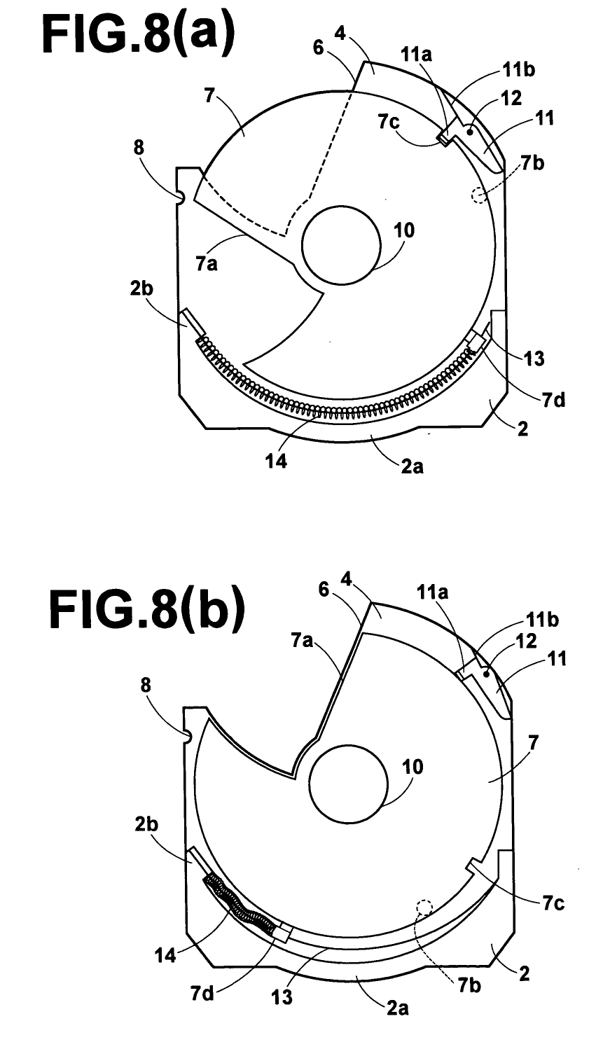

FIGS. 1(a) and (b) are plan views showing a magnetic disk cartridge of the present invention by contrasting with FIGS. 8(a) and (b), respectively. FIG. 1(a) shows a closed rotary shutter 7, and FIG. 1(b) show the open rotary shutter 7. Both FIGS. 1(a) and (b) show the rotary shutter 7 by removing an upper shell 3 and omitting a magnetic disk 5.

A coil spring 14 of a conventional magnetic disk cartridge shown in FIGS. 8(a) and (b) has an effective length of the entire rotation stroke of the rotary shutter 7. By contrast, the coil spring in the embodiment of the present invention shown in FIGS. 1(a) and (b) has the effective length of approximately half the rotation stroke of the rotary shutter 7. Other than the length, both cartridges have the same structure. Thus, the same reference numerals are used for the corresponding parts, and redundant descriptions are omitted.

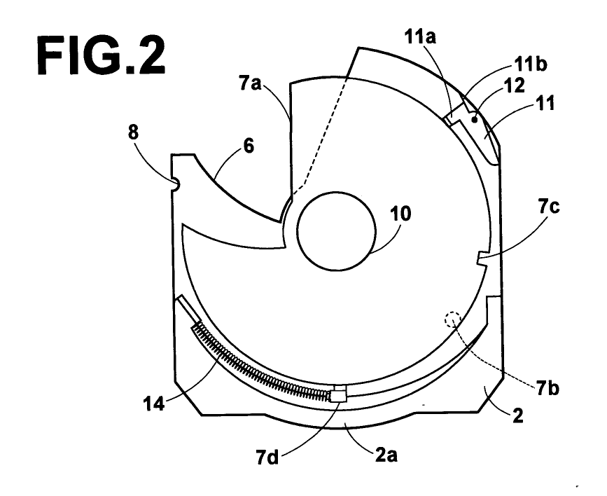

FIG. 2 shows a state where the rotary shutter 7 is stopped approximately half open when ejecting the magnetic disk cartridge 1 of the embodiment shown in FIGS. 1(a) and (b) from a disk drive 20 since the urging force of the coil spring 14 does not act on the rotary shutter 7.

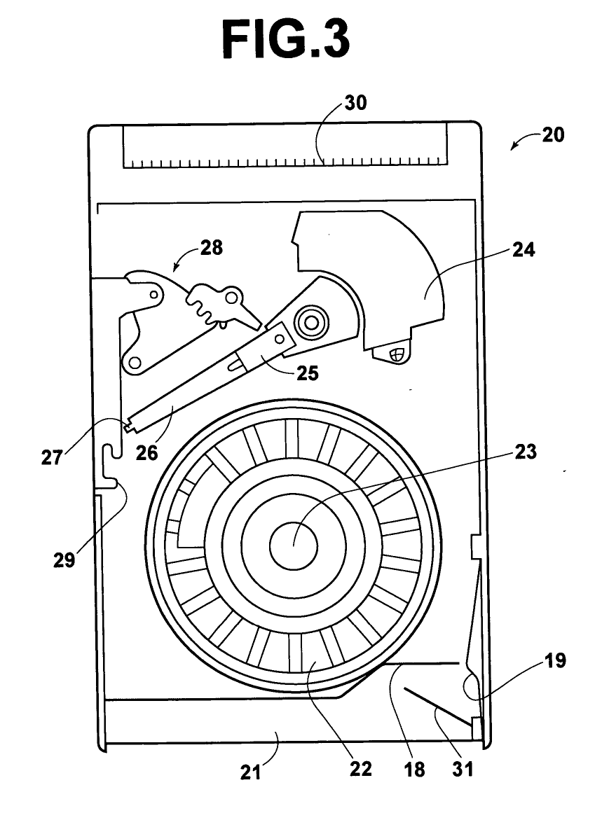

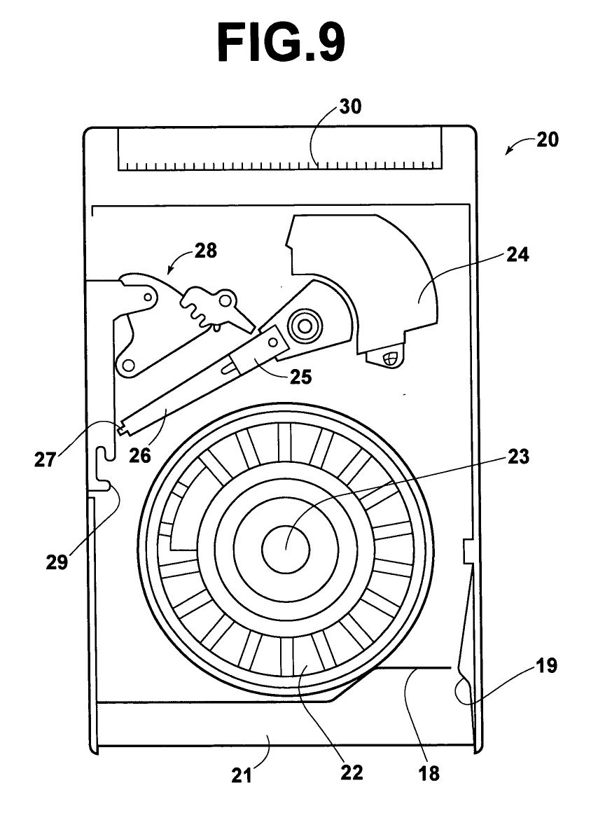

FIG. 3 is a plan view showing the disk drive 20 of the embodiment of the present invention by contrasting with a conventional disk drive 20 shown in FIG. 9. The only difference between the disk drives in FIGS. 3 and 9 is that an elastic member 31, which is a shutter closing means, is added to the disk drive in FIG. 3. Thus, similar to the magnetic disk cartridge 1, the same reference numerals are used for the corresponding parts, and redundant descriptions are omitted. The elastic member 31 is made of a metal or resin spring plate. The elastic member 31 is disposed at an angle before an engaging wall 18 and a lock releasing member 19 which are shutter opening means in order to be easily bent upon insertion. The engaging wall 18 bilaterally extends to be orthogonal to an insertion direction of the magnetic disk cartridge 1.

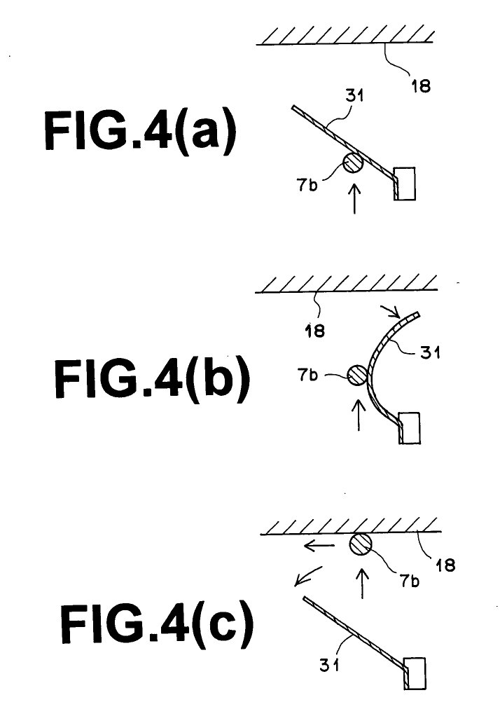

FIGS. 4(a) to (c) are explanatory views showing sequential operations of the elastic member 31 when inserting the magnetic disk cartridge 1 shown in FIG. 1 into the disk drive 20 shown in FIG. 3.

When inserting the magnetic disk cartridge 1 into a slot 21 of the disk drive 20, the lock releasing member 19 presses a shutter locking member 11 to release the rotary shutter 7 locked at a closed position. Prior to the release, when the shutter knob 7b engages with the elastic member 31 as shown in FIG. 4(a), the elastic member 31 is bent to allow the shutter knob 7b to pass through as shown in FIG. 4(b). At this point, by pressing the shutter locking member 11 with the lock releasing member 19, the shutter knob 7b engages with the engaging wall 18, the shutter opening means, as shown in FIG. 4(c), while the lock on the rotary shutter 7 is released. Thus, the rotary shutter is rotated to the open position as the magnetic disk cartridge 1 is further inserted.

Meanwhile, when inserting the magnetic disk cartridge 1 into the disk drive 20, the lock releasing member 19 presses the shutter locking member 11 to release the lock on the rotary shutter 7. Thereafter, as shown in FIG. 4(a), when the shutter knob 7b engages with the elastic member 31, the urging force of the coil spring 14 does not act on the rotary shutter 7 at all. Thus, the slightly bent elastic member as shown in FIG. 4(a) rotates the rotary shutter 7 halfway, and the urging force of the coil spring 14 begins to act on the rotary shutter 7. Accordingly, as shown in FIG. 4(b), the elastic member 31 is bent to allow the shutter knob 7b to pass through. At the same time, as shown in FIG. 4(c), the shutter knob 7b engages with the engaging wall 18, and the rotary shutter 7 is rotated to the open position.

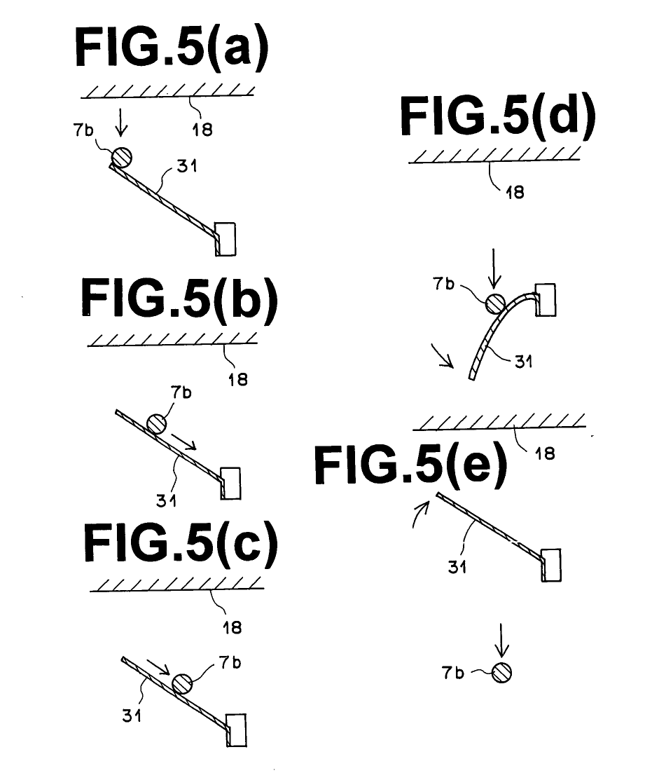

Next, FIGS. 5(a) to (e) are explanatory views showing sequential operations of the elastic member 31 when ejecting the magnetic disk cartridge 1 from the disk drive 20.

In this case, since the coil spring 14 has the effective length approximately half the rotation stroke of the rotary shutter 7, the urging force of the coil spring 14 does not act on the rotary shutter 7 in the middle of the ejection. Accordingly, the rotary shutter 7 stops, approximately half closed as shown in FIG. 3. Nonetheless, since the shutter knob 7b engages with the elastic member 31 as shown in FIG. 5(a), the rotary shutter 7 is rotated toward the closed position as the shutter knob 7b is slid along the angled surface of the slightly bent elastic member 31 as shown in FIG. 5(b). Accordingly, the rotary shutter 7 reaches the closed position in a state shown in FIG. 5(c). Therefore, the rotary shutter 7 is locked by the shutter locking member 11 at the closed position.

Furthermore, when removing the magnetic disk cartridge 1, since the rotary shutter 7 is locked, the elastic member 31 is bent by the shutter knob 7b to allow the shutter knob 7b to pass through as shown in FIG. 5(d). Thus, the magnetic disk cartridge 1 can be ejected as shown in FIG. 5(e).

As apparent from the above explanation, according to the magnetic disk cartridge 1 of the present embodiment, the coil spring 14 which urges the rotary shutter 7 to the closing direction has a short effective length of approximately half the rotation stroke of the rotary shutter 7. Accordingly, the coil spring 14 is easily incorporated into the cartridge housing, and the incorporating workability can be improved.

In addition, although the coil spring 14 having an effective length shorter than the rotation stroke of the rotary shutter 7 is employed, the coil spring 14 is compressed when the rotary shutter 7 is located at the open position. Accordingly, similar to the conventional magnetic disk cartridge, an initial speed of ejection and a balance of the cartridge can be ensured. Simultaneously, since the disk drive 20 is provided with the elastic member 31 serving as the shutter closing member, the rotary shutter 7 can be securely locked at the closed position when the magnetic disk cartridge 1 is ejected from the disk drive 20.

Note that the present embodiment is a magnetic disk cartridge which employs a magnetic disk as a recording medium. However, the present invention is not limited to this. The present invention can be applied to a disk cartridge provided with other types of recording media.

What is claimed is:

1. A disk cartridge in which a discoid recording medium is rotatably contained in a housing and which is inserted into a slot formed in a disk drive to be placed in the disk drive,
wherein the housing includes an opening for a read/write head of the disk drive to access a surface of the recording medium, a rotary shutter for opening/closing the opening while being urged by a spring member to a closing direction, and shutter locking means for locking the rotary shutter at a closed position,
the rotary shutter is constituted so that a lock on the rotary shutter is released by lock releasing means and shutter opening means provided in the disk drive when inserting the disk cartridge into the disk drive, and the rotary shutter is rotated to an open position so as to compress the spring member, and
the spring member constituted so that the spring member has an effective length shorter than a rotation stroke of the rotary shutter, and the rotary shutter is led to the closed position when ejecting the disk cartridge from the disk drive.

2. The disk cartridge according to claim 1,
wherein the spring member is constituted of a thin long coil spring which stretches and shrinks along a guide wire extended along a periphery of the rotary shutter.

3. The disk cartridge according to claim 2,
wherein the shutter locking means comprises:
a shutter locking member having a convex engaging portion which can engage with a concave engaging portion formed on the periphery of the rotary shutter, and provided rotatable between a shutter locking position where the convex engaging portion engages with the concave engaging portion and a lock releasing position where the convex engaging portion is escaped from the concave engaging portion in the housing; and
a second spring member which urges the shutter locking member toward the shutter locking position.

4. The disk cartridge according to claim 3, wherein the lock releasing means provided in the disk drive includes a lock releasing member which engages with the shutter locking member when inserting the disk cartridge into the disk drive and rotates the shutter locking member from the shutter locking position to the lock releasing position by resisting urging force of the second spring member.

5. The disk cartridge according to claim 4,
wherein an arcuate groove which is concentric with the rotary shutter is formed in the housing of the disk cartridge, and a shutter knob which protrudes from the arcuate groove and can move along the arcuate groove is attached to the rotary shutter, and
the shutter opening means provided in the disk drive includes an engaging wall which engages with the shutter knob of the rotary shutter released by the lock releasing means when inserting the disk cartridge into the disk drive and rotates the rotary shutter to the open position.

6. A disk drive including a slot to which a disk cartridge in which a discoid recording medium is rotatably contained in a housing is inserted, a driving mechanism which rotates the recording medium to be driven, and a read/write head which accesses a surface of the rotating recording medium to record/reproduce information,
wherein the housing of the disk cartridge is provided with an opening for the read/write head to access the surface of the recording medium, a rotary shutter which opens/closes the opening while being urged by a spring member to a closing direction, and shutter locking means for locking the rotary shutter at a closed position,
the disk drive further includes lock releasing means which releases a lock of the rotary shutter by the shutter locking means when inserting a disk cartridge into a disk drive, and shutter opening means which rotates the rotary shutter to an open position by resisting urging force of the spring member, and
the disk drive still further includes shutter closing means which leads the rotary shutter to the closed position by engaging with the rotary shutter when ejecting the disk cartridge from the disk drive.

7. The disk drive according to claim 6, wherein the shutter closing means is constituted of an elastic member.

8. The disk drive according to claim 6,
wherein the shutter locking means provided rotatable in the disk cartridge comprises:
a shutter locking member having a convex engaging portion which can engage with a concave engaging portion formed on a periphery of the rotary shutter, and provided between a shutter locking position where the convex engaging portion engages with the concave engaging portion and a lock releasing position where the convex engaging portion is escaped from the concave engaging portion in the housing; and
a second spring member which urges the shutter locking member toward the shutter locking position.

9. The disk drive according to claim 8,
wherein the lock releasing means includes a lock releasing member which engages with the shutter locking member when inserting the disk cartridge into the disk drive and rotates the shutter locking member from the shutter locking position to the lock releasing position by resisting urging force of the second spring member.

10. The disk drive according to claim 9,
wherein an arcuate groove which is concentric with the rotary shutter is formed in the housing of the disk cartridge, and a shutter knob which protrudes from the arcuate groove and can move along the arcuate groove is attached to the rotary shutter, and
the shutter opening means includes an engaging wall which engages with the shutter knob of the rotary shutter released by the lock releasing means when inserting the disk cartridge into the disk drive and rotates the rotary shutter to the open position.

11. The disk drive according to claim 10,
wherein the shutter closing means is constituted of an elastic member which is engaged with the shutter knob and bent by the shutter knob to allow the shutter knob to pass through when inserting the disk cartridge into the disk drive and engaged with the shutter knob to lead the rotary shutter to a closed position to be locked by the shutter locking member when ejecting the disk cartridge from the disk drive, and bent by the shutter knob to allow the shutter knob to pass through.
